(19) United States
(12) Patent Application Publication
(10) Pub. No.: US 2017/0273861 A1
(43) Pub. Date: Sep. 28, 2017

(54) SYSTEMS AND METHODS FOR WIRELESSLY CONTROLLED STIMULATION

(71) Applicants: Steven PAGE, Toronto (CA); Scott PATERNOSTER, New York, NY (US)

(72) Inventors: Steven PAGE, Toronto (CA); Scott PATERNOSTER, New York, NY (US)

(21) Appl. No.: 15/469,110

(22) Filed: Mar. 24, 2017

Related U.S. Application Data
(60) Provisional application No. 62/312,973, filed on Mar. 24, 2016.

(51) Int. Cl. A61H 19/00; A61H 23/02; G08C 17/02

(52) U.S. Cl. CPC A61H 19/50; G08C 17/02; A61H 19/32; A61H 19/34; A61H 23/02; A61H 2201/5097; A61H 2205/087

(57) ABSTRACT

A system for providing stimulation is provided configured for wireless communication sufficient to control a stimulator when the stimulator is positioned between the bodies of two users. The system includes a stimulator configured for positioning proximate to erogenous areas of two users, providing physical stimulation to the two users by way of the erogenous areas the two users, and wirelessly receiving one or more control signals controlling one or more characteristics of the provided physical stimulation; and a remote controller configured for wirelessly transmitting the one or more control signals to the stimulator, the remote controller adapted for transmitting electronic signals representative of the one or more control signals using a wireless frequency capable of maintaining a quality of signal sufficient to control operation of the stimulator during transmission through organic tissue of both of the users.

### CROSS REFERENCE

This application claims all benefit, including priority from, U.S. Application No. 62/312,973, entitled “SYSTEMS AND METHODS FOR WIRELESSLY CONTROLLED STIMULATION”, filed on 24 Mar. 2016, incorporated herein by reference.

### FIELD

The present disclosure generally relates to the field of stimulation devices for adult entertainment, and more specifically, systems and methods for wirelessly controlled stimulation for use with stimulation devices.

### INTRODUCTION

The control of stimulation devices between partners may be a desirable feature, for example, providing another aspect of entertainment between partners. However, a challenge with conventional wired stimulation devices is that control from a distance may be difficult to achieve without cumbersome wiring, which may be particularly disadvantageous in view of the limited space and potential discomfort in view of the erogenous areas stimulation devices are often proximate to.

As indicated throughout the specification, a challenge with wireless communications is achieving a suitably strong signal between a controller and a stimulation device when the stimulation device is being used proximate to two users' erogenous areas at the same time, such that the controller and stimulation device are able to communicate with one another.

### SUMMARY

In accordance with an aspect, there is provided a combination for providing erotic stimulation, the combination including: a stimulation unit (or stimulator) having a ring portion and a protrusion portion, the ring portion adapted for looping around a male sexual organ and the protrusion portion adapted for resting on or proximate to a female sexual organ, the stimulation unit adapted for providing physical stimulation to two users at the same time, and wirelessly receiving one or more control signals controlling one or more characteristics of the provided physical stimulation; and a remote controller unit configured for wirelessly transmitting the one or more control signals to the stimulation unit, the remote controller unit (or remote controller) adapted for transmitting electronic signals representative of the one or more control signals using a wireless frequency capable of maintaining a quality of signal sufficient to control operation of the stimulation unit during transmission when sandwiched between organic tissue of both of the users, the wireless frequency selected from the group of wireless frequencies between the range of about 300 MHz to about 450 MHz.

In another aspect, the wireless frequency is 315 MHz.

In another aspect, the wireless frequency is 433 MHz.

In another aspect, the wireless frequency is tunable to one or more wireless frequencies between about 300 MHz to about 450 MHz.

In another aspect, there is provided a system for providing erotic stimulation, the system comprising: a stimulation unit configured for positioning proximate to erogenous areas of two users at the same time, in order to provide physical stimulation to the two users by way of the erogenous areas of the two users, and wirelessly receiving one or more control signals to control one or more characteristics of the provided physical stimulation; a remote controller unit configured for wirelessly transmitting the one or more control signals to the stimulation unit, the remote controller unit adapted for transmitting electronic signals representative of the one or more control signals using a wireless frequency capable of maintaining a quality of signal sufficient to control operation of the stimulation unit via wireless transmission when the stimulation unit is substantially enveloped by organic tissue of both of the users.

In another aspect, positioning proximate to the erogenous areas includes positioning a ring portion of the stimulation unit around a penis of a first user; and the system further includes a tickler position for positioning the stimulation unit proximate a clitoris of a second user.

In another aspect, the stimulation unit is substantially enveloped by organic tissue of both of the two users, and the organic tissue includes at least one of bone, flesh, bodily fluids, and organ tissue.

In another aspect, the wireless frequency is also capable of maintaining a quality of signal sufficient to control operation of the stimulation unit during transmission through clothing worn by at least one of the two users.

In another aspect, the wireless frequency is also capable of maintaining a quality of signal sufficient to control operation of the stimulation unit during transmission through walls.

In another aspect, the wireless frequency is also capable of maintaining a quality of signal sufficient to control operation of the stimulation unit during transmission across a distance between about 3 feet and about 200 feet.

In another aspect, the wireless frequency is also capable of maintaining a quality of signal sufficient to control operation of the stimulation unit during transmission through a liquid or semi-liquid medium.

In another aspect, the wireless frequency is a wireless frequency selected from the group of wireless frequencies between the range of about 300 MHz to about 450 MHz.

In another aspect, the wireless frequency is about 315 MHz.

In another aspect, the wireless frequency is about 433 MHz.

In another aspect, the wireless frequency is tunable to one or more wireless frequencies between about 300 MHz to about 450 MHz.

In another aspect, the physical stimulation includes at least one of vibration, rotation, and translation.

In another aspect, there is provided a method for achieving erotic stimulation for a first person and a second person at the same time, the method comprising: mounting a stimulation unit having a ring portion and a protrusion portion on or about a sexual organ of the first person; engaging, by the first person, of the second person, such that the stimulation unit is substantially enveloped by flesh of the first person and flesh of the second person at the same time, the protrusion portion of the stimulation unit being placed proximate to, on, or about a sexual organ of the second person; and activating the stimulation unit using a wireless controller, the wireless controller adapted for wireless transmission of control signals to the stimulation unit while the stimulation unit is substantially enveloped by the flesh of the first person and the second person and the flesh of the second person, the wireless frequency selected from the group of wireless frequencies between the range of about 300 MHz to about 450 MHz.

In another aspect, there is provided a use of a combination according to any one of the above combinations or systems by the two users.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is an illustration of a user, with a stimulation unit between the bodies of two users being controlled a remote controller unit, according to some embodiments.

FIG. 2 is a block schematic diagram of the stimulation unit, according to some embodiments.

FIG. 3A provides a front view of a stimulation unit, according to some embodiments.

FIG. 3B provides a perspective view of a remote controller unit, according to some embodiments.

FIG. 3C provides a perspective view of a stimulation unit and a remote controller unit stored in a holder, according to some embodiments.

FIG. 4 is a side elevational view of the stimulation unit mounted on a penis, according to some embodiments.

FIG. 5 is a diagram illustrative of a sample transceiver in accordance to the first experimental analysis at 2450 MHz.

FIG. 6 is a waveform graph depicting the propagation of a radio-frequency signal broadcast from the device, in the context of the initial investigation.

FIG. 7 is a chart depicting attenuation of the radio-frequency signal when the transceiver is embedded in organic tissue in the context of the initial investigation.

FIG. 8 provides an illustration of a remote device, shown having buttons, according to some embodiments.

FIGS. 9A and 9B are graphs depicting magnetic field coupling between the transmitter and transceiver, according to some embodiments.

### DETAILED DESCRIPTION

Embodiments of methods, systems, and apparatus are described through reference to the drawings.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

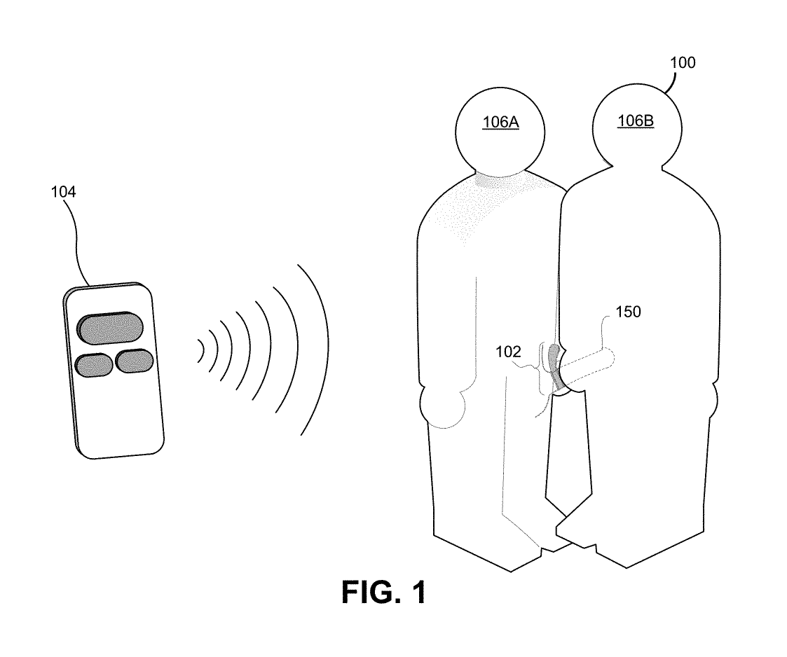

FIG. 1 is an illustration of a user, with a stimulation unit between the bodies of two users being controlled a remote controller unit, according to some embodiments.

As depicted, a system 100 may be comprised of various devices 102, 104, the devices interoperating to provide controlled stimulation to two users 106A and 106B, and the devices may be communicatively linked through wireless communication.

The system may include, for example, a stimulation unit 102 configured for (i) positioning proximate to one or more erogenous areas of two users and between the two users, (ii) providing physical stimulation to erogenous areas, and (iii) wirelessly receiving one or more control signals controlling one or more characteristics of the provided physical stimulation; and a remote controller unit 104 configured for wirelessly transmitting the one or more control signals to the stimulation unit 102, the remote controller unit 104 adapted for transmitting electronic signals representative of the one or more control signals using a wireless frequency capable of maintaining a quality of signal sufficient to control operation of the stimulation unit 102 during transmission through organic tissue of both of the users, when the stimulation unit 102 is in operation “sandwiched” between the two users.

The stimulation unit 102 is configured for various types or modes of operation. As depicted, the stimulation unit 102 is adapted to be worn on a penis (e.g., worn with the ring around the base of the penis, having a stimulator directed upward with “ticklers” facing upward). For example, the stimulation unit 102 may be slid over the penis until it sits comfortably against the scrotum of an individual. The stimulation unit 102 may be used with an erect penis, but may also be used on a flaccid or semi-erect penis. The penis 150 is shown in phantom as depicted in FIG. 1, the penis of user 106A may be inserted into a vagina of user 106B. As depicted in FIG. 1, part of the stimulation unit 102 is positioned around the penis 150 and part of the stimulation unit 102 is positioned in relation to an erogenous zone of a female, such that the stimulation unit 102 is able to provide pleasure to both users 106A and 106B simultaneously during intercourse or other sexual play.

For example, during intercourse, the stimulation unit 102 is adapted for touching and stimulating a woman's “erogenous zone” (on and around the clitoris) to provide arousing sensations. The stimulation unit 102 may be used in various positions of intercourse and sexual play, and accordingly, may not be limited to simply face-to-face interactions, etc. The stimulation unit 102, in some instances, may also be coated with various lubricants. As such, during operation, the stimulation unit 102 may often be “sandwiched” between two users.

Signal penetration is an important consideration and a challenge in relation to the stimulation unit 102, in view of its positioning and use in relation to the bodies of the users. Ensuring adequate communication between a stimulation device and a remote controller, when the device is “sandwiched” between the bodies of both users 106A and 106B is not trivial as experimental results indicated a high level of difficulty in achieving adequate control characteristics. A wireless frequency may require selection such that the signal is able to pass through the flesh of the users. Existing systems typically have an exposed feature while in use (in contrast, the system 100, when in use, is “sandwiched” between the two users), so this problem does not exist with existing systems.

As a further limitation, the system 100 may be restricted in frequency bands that it may operate in. For example, depending on the jurisdiction, some bands may not be available. These restrictions may impact the ability of the system 100 to communicate through various objects and materials. For example, restricted bands may have suboptimal spectral characteristics. Example bands include 900 MHz, 2.4 GHz, 5.8 GHz, etc.

As stimulation unit 102 is worn by a man during intercourse (it rests externally on the woman), the signal must penetrate two bodies when the bodies are enveloped together, possibly around the stimulation 102.

During experimentation, Applicants found that conventional signalling units provided inadequate signal characteristics for wireless control of stimulation units. A sufficiently strong signal is necessary to communicate (e.g., transmit) control signals indicative of various instructions in relation to stimulation unit 102. This problem is exacerbated by the environment and/or circumstances in which the stimulation unit 102 operates in (e.g., being effectively “sandwiched” between two users, potentially having various lubricants applied to it).

Whereas other types of stimulation devices may have an ability to have various aspects having exposure to air (and thus able to more readily transmit signals), in some circumstances and usage situations, the stimulation unit 102 may be fully enveloped by tissue. An increased challenge relative to having the signals simply penetrating the body of one user is encountered by stimulation unit 102 as the stimulation unit 102 is required to communicate through the bodies of two users who may be engaged in intercourse or other types of sexual play.

As discussed in various embodiments, an improved stimulation unit 102 in accordance with a transceiver is provided wherein the stimulation unit 102 is configured for wireless communication when the stimulation unit is positioned between the bodies of both users 106A and 106B.

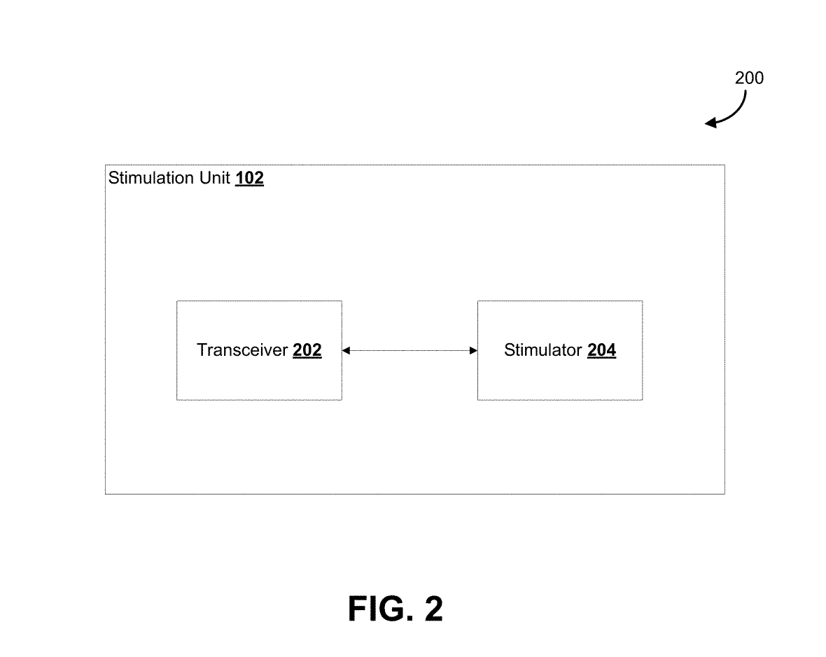

FIG. 2 is a block schematic diagram of the stimulation unit, according to some embodiments. The stimulation unit 102 may include, for example, a transceiver subunit 202 and a stimulator subunit 204.

The stimulation unit 102 and in accordance, the transceiver subunit 202, may be proximate to an erogenous zone of two users, and provide physical stimulation to the same. For example, the stimulation unit 102 may be placed on or around areas of the body to provide tactile and/or sensual sensory simulation.

Physical stimulation may be provided through a stimulator subunit 204 which for example, provides vibration using an on-board vibration unit such as a motor, rotation using a rotational motor, air-flow using, an air-flow pump, etc. There may be various types of movements provided, for example, translational motion (e.g., side to side, forwards and backwards), and rotational motion (e.g., clockwise, counter clockwise), or various combinations of both (translation while rotating). A tickler may, in some embodiments, be operated separately or simultaneously to the vibration of a ring portion.

The transceiver subunit 202 may be interconnected (e.g., coupled to) to the stimulator subunit 204 to control the operation of the stimulator subunit 204. In some embodiments, the stimulator subunit 204 may also communicate to the transceiver subunit 202 aspects related to its operation, which the transceiver subunit 202 may provide back to the remote controller unit 104. In some embodiments, the remote controller unit 104 may be configured to signal (e.g., through vibrations), operation of the stimulator subunit 204 (e.g., the operator of the remote controller unit 104 may be able to obtain tactile feedback in relation to the operation of the stimulator subunit 204).

Erogenous regions may be any portions of the body that may be capable of receiving sensory inputs, such as tactile sensations. While the stimulation unit 102, as depicted, is being utilized by placement of a ring portion on a penis and having a tickler for vibration on a woman's “pleasure zone” (e.g., on and around the clitoris), the stimulation unit 102 may also be used in relation to other erogenous areas such as, at least one of a back, a thigh, a vagina, a rectum, a prostate, a clitoris, an anus, an anal cavity, a mouth, and labia. Other regions may be included, for example, the inner elbow, the neck, behind the ears, areas on the head, etc.

Accordingly, the stimulation unit 102 may be, due to the positioning of the stimulation unit 102, be encased by or proximate to organic tissue, and the organic tissue includes at least one of bone, flesh, bodily fluids, and organ tissue. The entirety of the stimulation unit 102, or part of the stimulation unit 102 may be encased or proximate to tissue as it is used, in operation, between two bodies. The stimulation unit 102 may therefore be waterproof and/or water resistant such that the stimulation unit 102 is able to function in wet and/or semi-wet environments (e.g., wet due to the presence of bodily fluids, lubricants).

The remote controller unit 104 may be configured for transmission of various signals to/from the stimulation unit 102 to control aspects of operation of the stimulation unit 102. These signals may be generated and received by the transceiver subunit 202. The remote controller unit 104 may be used by a user him/herself, or by a partner (e.g., a partner holds the remote controller unit 104 and operates it to control the level of stimulation provided to both users may have the stimulation unit 102 between them (e.g., one user has a ring around the penis and the other user has a tickler next to a clitoris). Accordingly, the remote controller unit 104 may be operated through the use of various “buttons” or other types of input mechanism to cause stimulation effects.

In operation, the remote controller unit 104 sends electronic signals wirelessly to the stimulation unit 102, the stimulation unit 102 having a physical transceiver subunit 202 that receives the signals being issued (e.g., broadcasted) by the remote controller unit 104, and in accordance with the signals, may perform various activities, such as providing physical stimulation (e.g., through vibration using an on-board vibration unit such as a motor, rotation, air-flow stimulation).

The remote controller unit 104 may be in a line-of-sight correspondence with the stimulation unit 102, or may be not in a line-of-sight correspondence with the stimulation unit 102. The remote controller unit 104 may be sufficiently proximate to the stimulation unit 102 such that signals provided by the remote controller unit 104 may be received by the stimulation unit 102.

The remote controller unit 104 may be required to, for example, provide signals that are able to travel through organic tissue of the users (e.g., through bone, flesh, bodily fluids, and organ tissue), through clothing worn by the users (e.g., cotton, polyester), through walls, etc., in environments having varying spectral characteristics (e.g., signal reflections, transmission, attenuation, altitude, interference/noise). The distances required for transmission may be, for example, be between approximately 3 feet and approximately 200 feet, and may require operation through liquid, organic and/or semi-liquid media.

Accordingly, the selection of the transmission and/or communication characteristics of the remote controller unit 104 may have significant effects on the ability of the remote controller unit 104 to communicate and/or sufficiently issue signals to and/or receive signals from the stimulation unit 102.

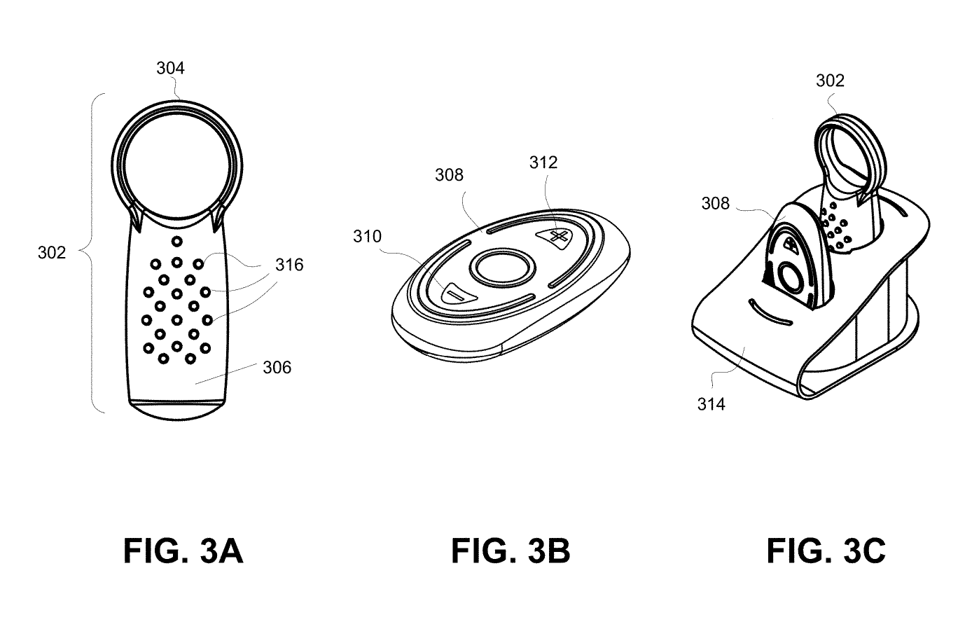

FIG. 3A provides a front view of a stimulation unit, according to some embodiments. The stimulation unit 302 shown in has a ring section 304, a body section 306, and various bumps 316. The ring section 304 may include, for example, an antenna section for transceiver subunit 202, and is fully enveloped when the stimulation unit 302 is in use. The body section 306 may include the stimulator subunit 204, which may, for example, move, vibrate, and/or otherwise cause physical stimulation of erogenous areas, e.g., by stimulating the area with the bumps 316. The ring section 304 may also be configured to cause physical stimulation of an erogenous areas.

For example, ring section 304 may be adapted for fitting around a penis of male. During intercourse, the body section 306 may rest and/or otherwise be proximate to a clitoris of a female. The vibrations provided by the stimulation unit, through both ring section 304 and body section 306, may provide sensory arousal to both the male and female during intercourse or other sexual play. However, the male or female may wish to operate the stimulation unit 302 remotely as a means to increase enjoyment of intercourse or other sexual play.

FIG. 3B provides a perspective view of a remote controller unit, according to some embodiments. The remote controller 308 may include buttons 310 and 312, which may be used to control various characteristics of operation of the stimulation unit 302. For example, the buttons 310 and 312 may control how vigorously the stimulator subunit 204 is operated, etc. The remote controller 308 wirelessly communicates with the stimulation unit 302.

FIG. 3C provides a perspective view of a stimulation unit and a remote controller unit stored in a holder, according to some embodiments. The holder 314, may, in some embodiments, be configured to charge (e.g., wirelessly or wired) the stimulation unit 302 and/or the remote controller 308.

Applicants undertook a process of selecting and/or configuring a stimulation device having remote controller features such that the device would be sufficiently able to communicate wirelessly with a remote controller in environments described above.

Through the course of Applicants' experimental analysis, Applicants discovered a technical problem in relation to communications through flesh and/or other organic matter in relation to stimulation devices, finding that signals were often significantly attenuated in the course of travel between a controller and a stimulator unit. Applicants conducted experiments on several devices on the market and developed a prototype, finding that the communications were less than adequate for sustained usage at distance.

For example, many frequencies were unsuitable for usage for various reasons, such as having a low signal to noise ratio, being unable to sufficiently penetrate organic and/or inorganic material to provide control signals, being provided in crowded and/or noisy signal frequency ranges, etc. The lack of a strong signal being provided may cause various undesirable effects, such as an inability to issue control signals, an inability to activate a device, an inability to deactivate a device, etc. This problem may become more significant depending on the amount of organic and inorganic tissue that may be present in the path of a signal.

Applicant was further constrained in view of various regulatory requirements limiting the total transmission power (e.g., to limit the amount of absorbed radiation in human flesh) and/or bandwidth available for such communications. Accordingly, a technical solution could not be simply to increase the power of transmission as such an approach would fall afoul of the various regulatory requirements.

In the course of Applicants' design and manufacturing process, Applicants tested various frequency bands and found that many were unsuitable for use (e.g., 2.4 GHz) as intended by the Applicants for communication through various tissues at distances in real-world spectral environments.

Applicants underwent a design and testing process where devices having different characteristics were tested, and underwent various experimental trials to determine a set of frequency ranges that are sufficiently operable such that signals may be communicated with a suitable signal to noise ratio and range for operation in various environments and contexts (e.g., through walls, through clothes, in the presence of wireless communication noise).

Based on Applicants' experimental results, Applicants found that communications in a frequency of approximately 315 MHz and a frequency of 433 MHz were advantageous relative to communications operating at 2450 MHz, in particular, where tissue analogues were used to simulate real-world conditions.

Accordingly, in various embodiments, the remote unit and the stimulation unit 102 may be configured to interoperate at approximately either one of these two frequencies, and in some embodiments, both frequencies simultaneously or alternatively to one another. In some embodiments, the remote unit and the stimulation unit 102 may be tunable between the two frequencies (300 MHz and 450 MHz).

In some embodiments, the antenna shape for the transceiver subunit 202 is provided in the shape of a or may be a loop. The loop may be configured in various ways, for example, surrounding the full perimeter of the unit, or may surround only part of the unit. There may be advantages in having the loop as large as possible, especially for operation using frequencies at approximately 315 MHz and approximately 433 MHz, or tunable to frequencies in between (e.g., to avoid spectral noise, other propagated signals, spectral separation [“channels”] where multiple devices are being used around one another). There may be a “ring shape” provided in relation to the stimulation unit 102 (e.g., the ring holding the transceiver antenna) and being configured for facilitating easier removal and/or improving spectral/communication features of the transceiver subunit 202. For example, the stimulation unit 102 may include two sections, a first section including a stimulator for causing physical stimulation, and the second section including an antenna that is configured for wirelessly receiving and/or transmitting control signals that may control and/or otherwise communicate characteristics of the provided physical stimulation. Referring to FIG. 3A, two sections 304 and 306 are shown.

The first section 306 may, for example, be placed next to a clitoris (e.g., during intercourse) and a second section 304 may be placed around a penis. Where the antenna is a loop, Applicants found that while the inside of the loop can have metallic objects, Applicants found that it was advantageous to reduce their profile, or at least to reduce contiguous metal. In some embodiments, the loop has some metallic objects, and in other embodiments, the loop has no contiguous metallic objects. In some embodiments, variability (tolerance) with metal content inside the loop has been reduced, as the variability may lead to a detuning of the antenna. The antenna may be constructed from various types of materials and components, such as 24 AWG or 26 AWG magnet wire.

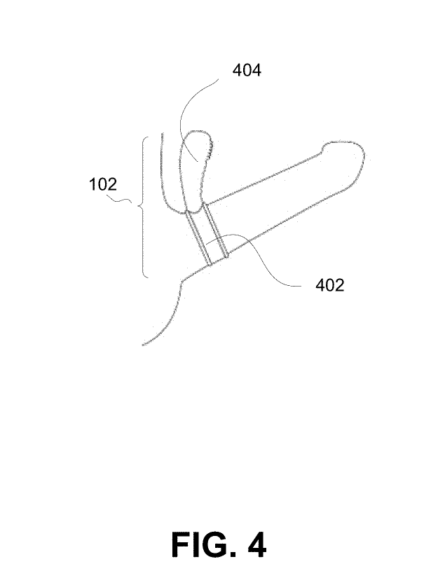

FIG. 4 is a side elevational view of the stimulation unit 102 mounted on a penis, according to some embodiments. As depicted, stimulation unit 102 may include at least a ring or loop 402 which is adapted to fit around the penis of a male and a tickler 404, which may have ridges and/or other features designed to aid in the stimulation of erogenous zones of a sexual partner, such as a clitoris.

In some embodiments, the stimulation unit 102 may be adapted such that other wires should not run parallel to the antenna, and the geometry of the antenna do not vary. The antenna may be soldered directly to the PC board with no slack, or coupled and/or attached in other ways.

### Experimental Analysis

Applicants conducted tests where a number of prototypes and conventional vibrator models were tested. Applicants tested a vibrator model, the WeVibe 3™, that operated at about 2.45 GHz, testing the unit through destructive disassembly. The battery required approximately 8 hrs to charge and the vibrator was claimed to have 2 hr battery life “depending on vibration mode”. The remote for the WeVibe 3™, was tested in various transmission conditions, including open air and within the tissue phantom. A tissue phantom was a test apparatus made to simulate conditions where the device would be enveloped in human tissue.

Applicants found that the technical problem of transmitting signals through tissue (e.g., analogous to the tissue phantom) was found when testing the WeVibe 3™ with the tissue phantom. Applicant found that remote connectively significantly attenuated and did not function (e.g., cut out completely) when embedded in the tissue phantom at around 5 cm.

A Lelo Oden 2™ unit was also examined. The antenna of the Lelo Oden 2™ unit is not in the loop, and rather, provided on the PC Board. The unit is not wirelessly charged and not submersible. The Lelo Oden 2™ unit is provided with two styles of loops that screw onto the base at the shiny band, hiding the charge port. The Lelo Oden 2™ appeared to operate at about 2.4 GHz.

The vibration level was noticeably lower than the We Vibe3™ and the motor is physically about half the size. The battery is flat and appeared to be a a Lithium Ion battery. The Lelo Oden 2™ unit performed adequately in the tissue phantom up to 2″ depth and 4 ft separation. However, at 4″ and 2 ft separation, communication became unreliable.

The Lelo Oden 2™ unit provided vibration feedback at transmitter, where the transmitter can vibrate with the same pattern as the transceiver, although it is not fully synchronized. The transmitter vibration can be disabled by holding down one of the buttons.

Communications for the Lelo Oden 2™ unit were bidirectional, and Applicants found that when communication were out of range, the transmitter was unresponsive. While the two devices should have been provided in synchronicity (e.g., operation between the two devices in maintained lock step), Applicants found that often the remote was in one mode while the transceiver was in another.

### Experimental Analysis—2.45 GHz

Initial testing provided for the reproduction of the technical problem of transmitting signals through an initial tissue model. The initial tissue model was created in accordance with the tissue phantom models provided in the appendix section of this description.

Applicants tested the unit in an open field and found that it was able to communicate up to a distance of 200 ft. However, when immersed in a liquid tissue phantom (body model), the unit would cut out when submerged more than 1.0″ below the surface with the remote at a 3 ft distance.

The initial unit operated at 2450 MHz, and tissue losses were found in the range of 30 dB.

Accordingly, Applicants found that such losses were unsuitable for use and considered abandoning operation at 2450 MHz for a potential follow-on test for operation at 315/433 MHz.

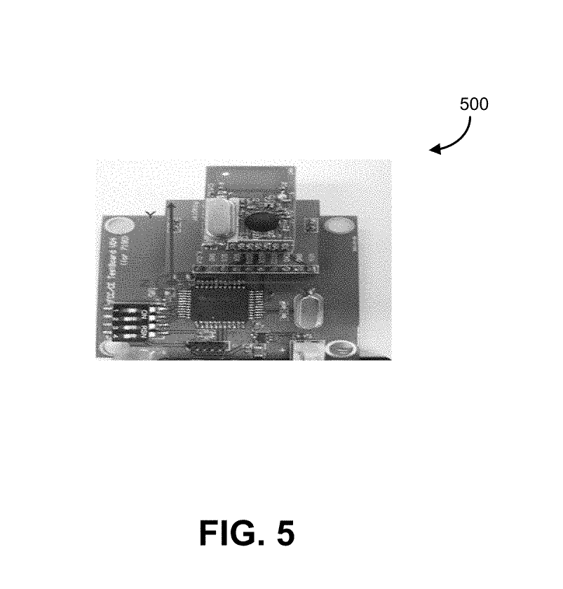

FIG. 5 is a diagram illustrative of a sample transceiver 500 in accordance to a first experimental analysis at 2450 MHz.

The transceiver may be implemented using various components, some of the components including electronic circuitry for communications, microprocessors, memory, computer-readable storage, etc. The transceiver may include an antenna module (e.g., a Amicom M06E-C™ antenna module Loop antenna), operates at various frequencies (e.g., 2.45 GHz), uses a transceiver module (e.g., an Amicom A7105™ chip, having −107 dBm sensitivity at 2 Kbps) that may support communications (e.g., 1 way, 2 ways). The transmission strength may be set at various settings (e.g., maximum) for the device (e.g., 0 dBm setting, measured at +1 dBm on a prototype), having a data rate (e.g., set at 5 kbps). The transceiver may have an associated free air range, such as approximately 15 ft (when the antenna is matched to free air).

Applicants discussed the creation of various models for reproducing test conditions, and developed several “phantom models” having characteristics that approximated and/or were similar to real-world conditions faced by the devices, including density, moisture, etc.

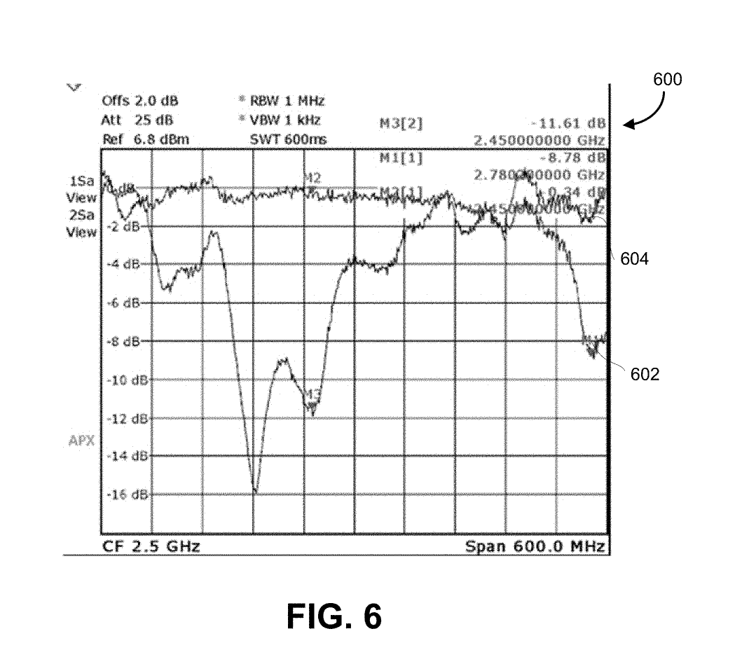

FIG. 6 is a waveform graph depicting the propagation of a radio-frequency signal broadcast from an embodiment of the device, in the context of the initial investigation. The antenna has been matched (tuned) for operation in embedded tissue. A signal trace 600 is shown. The first trace 602, shown in blue, indicates the analysis in relation to air. The second trace, 604, shown in black, illustrates the analysis when the antenna is transmitting through a saline solution (S11=−11 dB).

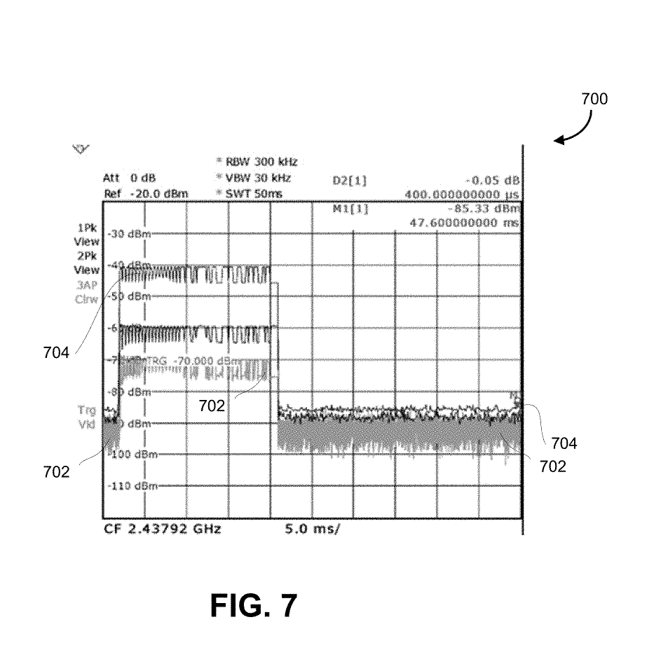

FIG. 7 is a chart depicting attenuation of the radio-frequency signal when an embodiment of the transceiver is embedded, for example, in organic tissue in the context of the initial investigation.

In the initial investigation, the investigation found that embedded tissue attenuation was measured at approximately 30 dB. roughly equivalent to a factor of 32 in range loss (degrading 5 ft to approximately 6 inches). In the chart 700, the lower trace 702 is provided for tissue, and the upper trace 704 is provided for air.

Accordingly, Applicants found that there existed a need to extend operation to approximately 4 ft with the embedded tissue use case (e.g., needing an additional 18 dB of gain). As described in various embodiments, frequency range modifications to use unconventional frequency ranges were found to aid reliable propagation of signals when the stimulation device was sandwiched between two individuals (e.g., during operation, in some instances).

### Experimental Analysis—315/433 MHz

Applicants performed various testing at example frequency ranges 315/433 MHz. Lower frequencies may be advantageous for signal penetration, however, a trade-off may be the presence of potential background noises in this frequency band. There may be advantages for frequencies tuned in ranges around 315/433 MHz as well. For example, such tuning may be useful where channel separation is needed between devices.

Applicants considered various models using frequencies within the range of 315/433 MHz (e.g., an A7108 Amicom transceiver), and found that device provides approximately 117−107+17−1=26 dB signal advantage relative to the test at 2450 MHz. Applicants' investigation found that operating at the device to communicate at 433 MHz provided a >30 dB advantage as compared to operating the device to communicate at 2450 MHz, and further noted that a 433 MHz antenna efficiency will introduce ˜10 dB losses, providing a total advantage in the order of 26+30−10=46 dB, where an approximately 20 dB advantage was required over the initial design.

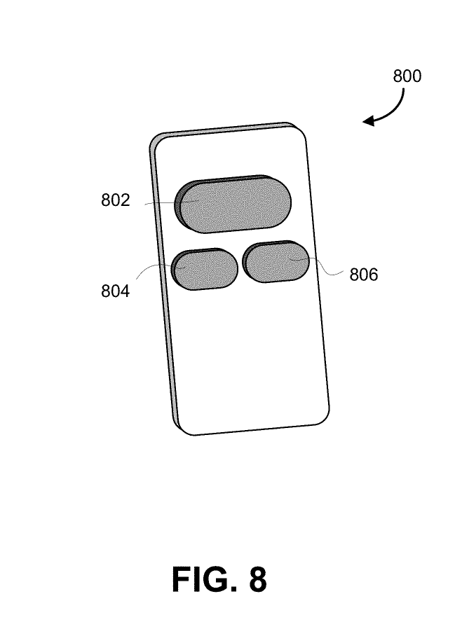

Tests were also performed using a remote device (e.g., Liftmaster 890 MAX™) that operated at 315 MHz, and tests were favorable. FIG. 8 provides an illustration of a remote device 800, shown having buttons 802, 804, and 806.

The operation at 315 MHz was minimally impacted by the tissue model, and Applicants found that a spectrum analyzer indicated a 6 dB variation in signal between tissue and no tissue. The Liftmaster 890 MAX™ included a loop antenna for use with communications. Based on experimentally derived results, Applicants found that the signal was the signal was minimally affected by the phantom tissue model. Signal levels varied by approximately 6 dB which equates to approximately a factor of 2 in distance, and in some experimental cases, the signal was stronger when surrounded by the tissue phantom. Based on Applicants' testing with a 315 MHz receiver, the 315 MHz receiver was able to receive signal to about 60 ft with or without tissue phantom.

In comparison, at 2450 MHz, Applicants' test models were losing about 30 dB which equated to a factor of 32 in distance reduction from free space.

A potentially suitable form factor may be a remote that measures 63×33×13 mm intended to be hand held.

### Embedded Ring

Applicants considered embedded an antenna into a ring portion of the stimulator unit to determine whether it would help signal strength. Applicants noted that such a configuration would need to survive several hundred (500+) cycles to be proven reliable, and the wire should not have a noticeable feel for the user, and even with wear and tear the ends of the wire should not be able to poke out of the ring.

Applicants considered the effect of tissue geometry, noting that the maximum surrounding tissue geometry may be a condition for consideration for testing. In some use cases, the ring may be enveloped in tissue, skin or fat fold.

Antennas may be made of various components, such as flexible wires made of stranded copper or conductive silicone, or in some embodiments, a conductive silicone solution.

### Measuring Tissue Attenuation—Comparing Operating at 2450 MHz to 433 MHz

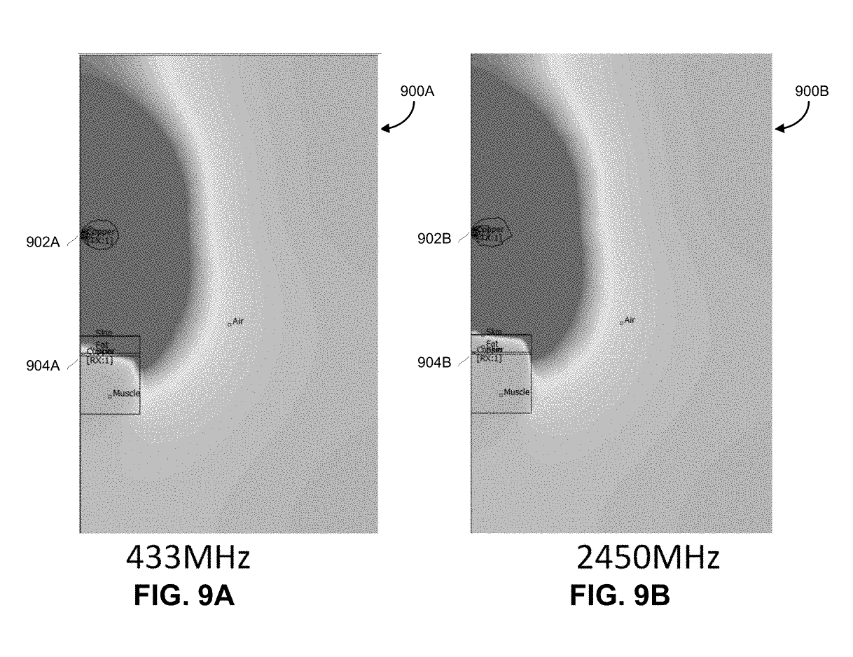

FIGS. 9A and 9B are graphs 900A and 900B depicting magnetic field coupling between the transmitter 902A, 902B and transceivers 904A, 904B, according to some embodiments. As indicated in FIG. 9A and FIG. 9B, the magnetic field coupling between transmitter to transceiver improves by approximately 38 dB from 2450 MHz (FIG. 9B) to 433 MHz (FIG. 9A).

The following Table, Table 1, is provided for illustrating a comparison between A7105 and the A7108 chips.

TABLE 1

| Key Parameter | A7105 | A7108 |
|---|---|---|
| Frequency (MHz) | 2450 | 433 |
| 2 kHz sensitivity (dBm) | −107 | −117 |
| Max TX power (dBm) | +1 | +17 |

The embodiments of the devices, systems and methods described herein may be implemented in a combination of both hardware and software. In some embodiments, computer-readable media may be provided for storing instructions, which when executed by a processor, cause the processor to perform various steps.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A combination for providing erotic stimulation, the combination comprising:
a stimulator having a ring portion and a protrusion portion, the ring portion adapted for looping around a male sexual organ and the protrusion portion adapted for resting on or proximate to a female sexual organ, the stimulator adapted for providing physical stimulation to two users concurrently, and wirelessly receiving one or more control signals controlling one or more characteristics of the provided physical stimulation; and a remote controller configured for wirelessly transmitting the one or more control signals to the stimulator, the remote controller adapted for transmitting electronic signals representative of the one or more control signals using a wireless frequency capable of maintaining a quality of signal sufficient to control operation of the stimulator during transmission when sandwiched between organic tissue of the two users, the wireless frequency selected from the group of wireless frequencies between the range of about 300 MHz to about 450 MHz.

2. The combination of claim 1, wherein the wireless frequency is 315 MHz.

3. The combination of claim 1, wherein the wireless frequency is 433 MHz.

4. The combination of claim 1, wherein the wireless frequency is tunable to one or more wireless frequencies between about 300 MHz to about 450 MHz.

5. A system for providing erotic stimulation, the system comprising:
a stimulator configured for positioning proximate to erogenous areas of two users at the same time, in order to provide physical stimulation to the two users by way of the erogenous areas of the two users, and wirelessly receiving one or more control signals to control one or more characteristics of the provided physical stimulation;
a remote controller configured for wirelessly transmitting the one or more control signals to the stimulator, the remote controller adapted for transmitting electronic signals representative of the one or more control signals using a wireless frequency capable of maintaining a quality of signal sufficient to control operation of the stimulator via wireless transmission when the stimulator is substantially enveloped by organic tissue of both of the users.

6. The system of claim 5, wherein positioning proximate to the erogenous areas includes positioning a ring portion of the stimulator around a penis of a first user; and the system further includes a tickler position for positioning the stimulator proximate a clitoris of a second user.

7. The system of claim 6, wherein the stimulator is substantially enveloped by organic tissue of both of the two users, and the organic tissue includes at least one of bone, flesh, bodily fluids, and organ tissue.

8. The system of claim 5, wherein the wireless frequency is also capable of maintaining a quality of signal sufficient to control operation of the stimulator during transmission through clothing worn by at least one of the two users.

9. The system of claim 5, wherein the wireless frequency is also capable of maintaining a quality of signal sufficient to control operation of the stimulator during transmission through walls.

10. The system of claim 5, wherein the wireless frequency is also capable of maintaining a quality of signal sufficient to control operation of the stimulator during transmission across a distance between about 3 feet and about 200 feet.

11. The system of claim 5, wherein the wireless frequency is also capable of maintaining a quality of signal sufficient to control operation of the stimulator during transmission through a liquid or semi-liquid medium.

12. The system of claim 5, wherein the wireless frequency is a wireless frequency selected from the group of wireless frequencies between the range of about 300 MHz to about 450 MHz.

13. The system of claim 5, wherein the wireless frequency is about 315 MHz.

14. The system of claim 5, wherein the wireless frequency is about 433 MHz.

15. The system of claim 5, wherein the wireless frequency is tunable to one or more wireless frequencies between about 300 MHz to about 450 MHz.

16. The system of claim 5, wherein the physical stimulation includes at least one of vibration, rotation, and translation.

17. A method for achieving erotic stimulation for a first person and a second person at the same time, the method comprising:
mounting a stimulator having a ring portion and a protrusion portion on or about a sexual organ of the first person;
engaging, by the first person, of the second person, such that the stimulator is substantially enveloped by flesh of the first person and flesh of the second person at the same time, the protrusion portion of the stimulator being placed proximate to, on, or about a sexual organ of the second person; and
activating the stimulator using a wireless controller, the wireless controller adapted for wireless transmission of control signals to the stimulator while the stimulator is substantially enveloped by the flesh of the first person and the second person and the flesh of the second person, the wireless frequency selected from the group of wireless frequencies between the range of about 300 MHz to about 450 MHz.

18. A use of the combination according to claim 1 by the two users.
